(19) United States
(12) Patent Application Publication
(10) Pub. No.: US 2008/0075519 A1
(43) Pub. Date: Mar. 27, 2008

(54) TWIST PREVENTING MEDIUM PICKUP UNIT AND AN IMAGE FORMING APPARATUS HAVING THE SAME INSTALLED THEREIN

(75) Inventor: Chun-seung YANG, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/737,347

(22) Filed: Apr. 19, 2007

(30) Foreign Application Priority Data
Sep. 25, 2006 (KR) 2006-92953

(51) Int. Cl. B41J 13/10

(52) U.S. Cl. 400/636

(57) ABSTRACT

A medium pickup unit including a pickup roller, having a circumferential section and a non-circumferential section, to rotate and to pick up a medium due to friction between the circumferential section and the medium, idle rollers respectively disposed at opposite ends of the pickup roller to maintain an orientation of the medium once the non-circumferential section of the pickup roller faces the medium during the rotation of the pickup roller, and a connecting unit coupled to the pickup roller to cause the idle rollers to rotate together.

### CROSS-REFERENCE TO RELATED APPLICATION

This application claims the benefit of Korean Application No. 2006-92953, filed Sep. 25, 2006 in the Korean Intellectual Property Office, the disclosure of which is incorporated herein by reference.

### BACKGROUND OF THE INVENTION

1. Field of the Invention

An aspect of the present invention relates to an image forming apparatus. More particularly, aspects of the present invention relate to a medium pickup unit capable of preventing a medium that is being picked up and conveyed from being twisted, and an image forming apparatus having the same installed therein.

2. Description of the Related Art

Generally, an image forming apparatus includes a medium pickup unit and a medium conveying unit. The medium pickup unit picks up media (i.e., printing paper, transparencies, etc.) accommodated in a medium supplying cassette in a one by one sequence. The medium conveying unit conveys the picked up medium toward a developing unit.

FIG. 1 is a perspective view exemplifying a medium supplying cassette and a medium pickup unit of a general image forming apparatus, FIG. 2 is a perspective view exemplifying the medium pickup unit selected from FIG. 1, and FIG. 3 is a side elevation view of FIG. 1. As is illustrated in the drawings, media are accommodated in the medium supplying cassette 10, and are urged and supported upward by a knockup plate 11. As illustrated in FIG. 3, the knockup plate 11 is lifted to a position where the accommodated media contacts a medium pickup unit 20.

The medium pickup unit 20 is operated according to a printing signal inputted thereto. When a pickup command is issued, the medium pickup unit 20 picks up the accommodated media in a one by one sequence and conveys the picked-up medium toward a medium conveying unit 30.

The medium pickup unit 20 includes a pickup roller 21, and idle rollers 22 disposed at both sides of the pickup roller 21. As illustrated in FIG. 2, the pickup roller 21 is not formed in an exact circular shape, but, rather, in a semicircular shape having a circumferential section and a non-circumferential section. Since the circumferential section contacts the medium, the circumferential section conveys the medium by a friction therewith toward the medium conveying unit 30. The circumferential section has a diameter slightly larger than that of the idle rollers 22. Accordingly, when the pickup roller 21 picks up the medium with the circumferential section thereof, the idle rollers 22 are spaced apart from the medium and, thus, are not rotated.

Then, as the pickup roller 21 continues to rotate, the non-circumferential section of the pickup roller 21 separates from the medium, and the idle rollers 22 contact the medium. At this time, since the medium, having been separated from the pickup roller 21, is continuously conveyed by a conveying roller 31 and a conveying idle roller 32 of the conveying unit 30, the idle rollers 22 are idled due to friction with the medium.

On the other hand, since the idle rollers 22 disposed at both sides of the pickup roller 21 are configured to be independently idle with respect to each other, they cannot restrain the medium from twisting left and right. Accordingly, to prevent the medium from twisting until a rear end of the medium is completely released from the medium supplying cassette 10, a medium aligning device 12 is formed and disposed in a size corresponding to that of the medium at left and right sides of the medium supplying cassette 10.

However, because of the construction of the medium supplying cassette 10, the medium aligning device 12 cannot be formed to be long enough long to sufficiently extend in a longitudinal direction of a medium. Accordingly, when media, such as letter-sized papers, A4-sized papers, legal-sized papers, or the like, which are elongated in the longitudinal direction, move in a direction of arrow A in FIG. 1, a rear end of the medium is not guided by the medium aligning device 12. As a result, a particular elongated medium may twist, with the rear end thereof being shaken, in a direction of arrow B in FIG. 1. While being conveyed, the twisted medium is likely to be increasingly twisted, so that it is difficult for a desired image to be printed on the medium. In the worst case, a medium supplying error may occur, in which a medium is jammed in the apparatus.

### SUMMARY OF THE INVENTION

Aspects of the present invention have been developed in order to solve the above and/or other problems. Accordingly, the present invention provides a medium pickup unit having an improved structure to prevent a medium from twisting during pickup and conveyance operations of the medium, and an image forming apparatus having the same installed therein.

The foregoing and/or other aspects and utilities of the present invention may be achieved by providing a medium pickup unit including a pickup roller, having a circumferential section and a non-circumferential section, to rotate and to pick up a medium due to friction between the circumferential section and the medium, idle rollers respectively disposed at opposite ends of the pickup roller to maintain an orientation of the medium once the non-circumferential section of the pickup roller faces the medium during the rotation of the pickup roller, and a connecting unit coupled to the pickup roller to cause the idle rollers to rotate together.

According to an exemplary embodiment of the present invention, the connecting unit includes an idle pin to penetrate the pickup roller, planet gears disposed on both ends of the idle pin, respectively, and sun gears disposed on the idle rollers to engage with the planet gears, respectively.

The planet gears rotate and simultaneously revolve around the sun gears when the pickup roller rotates to pick up a medium, and rotate in connection with rotations of the sun gears when the idle rollers are rotated by the picked-up medium.

According to another exemplary embodiment of the present invention, the connecting unit includes an idle pin to penetrate the pickup roller, planet gears disposed on both ends of the idle pin, respectively, and ring gears disposed on inner circumferential surfaces of the idle rollers to engage with the planet gears, respectively.

The planet gears rotate and simultaneously revolve along the ring gears when the pickup roller rotates to pick up a medium, and rotate in connection with rotations of the ring gears when the idle rollers are rotated by the picked-up medium.

The foregoing and/or other aspects and utilities of the present invention may also be achieved by providing an image forming apparatus including a medium supplying cassette, and the medium pickup unit as described above to pick up a medium accommodated in the medium supplying cassette.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view exemplifying a medium supplying cassette and a medium pickup unit of a general image forming apparatus;

FIG. 2 is a perspective view exemplifying the medium pickup unit of FIG. 1;

FIG. 3 is a side elevation view exemplifying an operation of the medium pickup unit of FIG. 1;

FIG. 4 is a top plan view exemplifying a medium supplying cassette and a medium pickup unit of an image forming apparatus according to an embodiment of the present invention;

FIG. 5 is a top plan view exemplifying the medium pickup unit according to the embodiment of FIG. 4;

FIG. 6 is an exploded perspective view exemplifying the medium pickup unit of FIG. 5;

FIGS. 7 and 8 are partial perspective views exemplifying a connection relation of an connecting unit interposed between a pickup roller and idle rollers in the medium pickup unit of FIG. 5;

FIGS. 9 and 10 are schematic views exemplifying an operation principle of the medium pickup unit of FIG. 5;

FIGS. 11 and 12 are partial perspective views exemplifying a connection relation of an connecting unit interposed between a pickup roller and idle rollers in a medium pickup unit according to another exemplary embodiment of the present invention;

FIG. 13 is a schematic view exemplifying an operation principle of the medium pickup unit of FIG. 11; and

FIG. 14 is a side view of an image forming apparatus according an embodiment of the present invention.

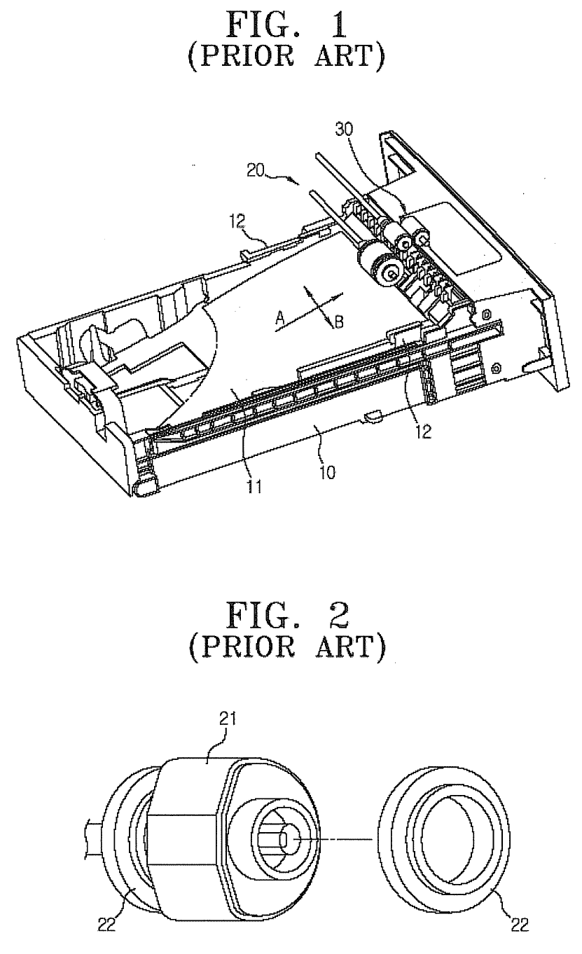

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

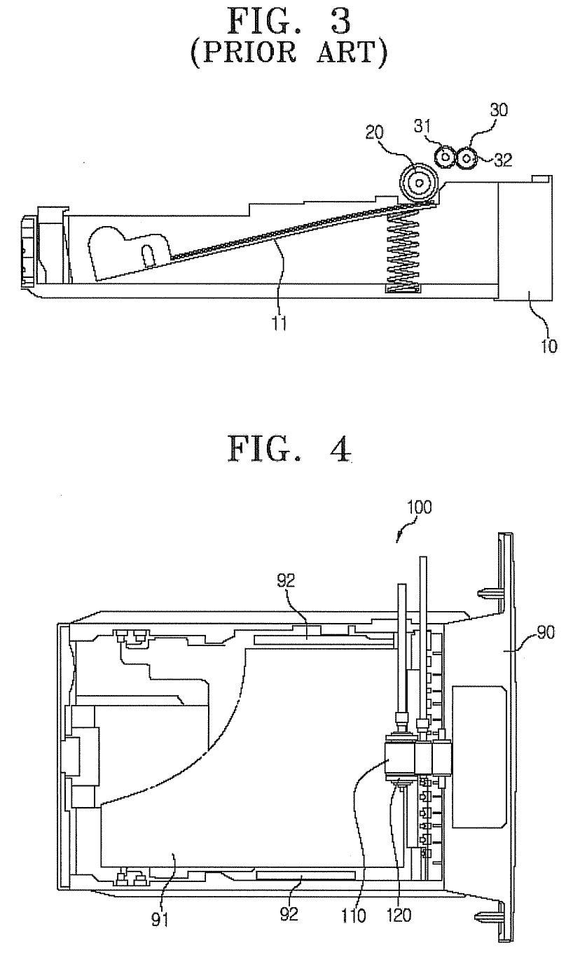

As illustrated in FIGS. 4, 5 and 6, a medium pickup unit 100, according to an embodiment of the present invention, includes a pickup roller 110, idle rollers 120, and a connecting unit 130. The pickup roller 110 has a circumferential section and a non-circumferential section, and the idle rollers 120 are disposed at both sides of the pickup roller 110. The connecting unit 130 connects the idle rollers 120 to one another so that the idle rollers 120 rotate together and at the same speed.

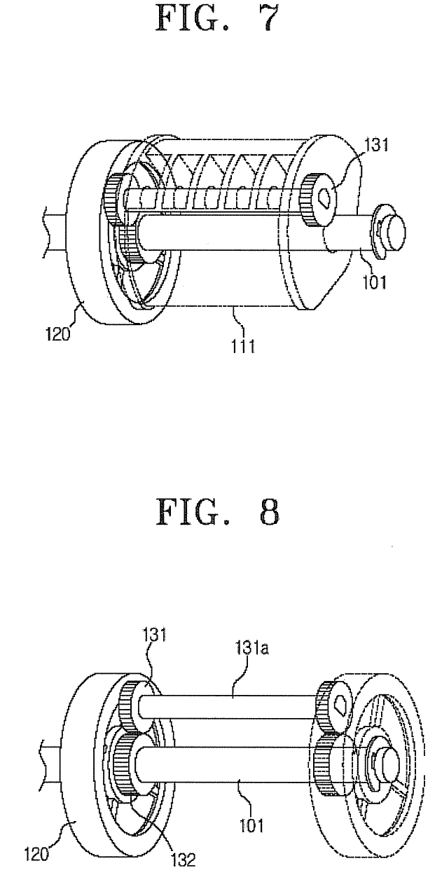

As illustrated in FIG. 6, the connecting unit 130 includes an idle pin 131a, planet gears 131, and sun gears 132. The idle pin 131a penetrates the pickup roller 110 and in coupled to the pickup roller 110. As illustrated in FIGS. 6 and 7, the idle pin 131a is rotatably disposed in a pinhole 111a formed in a pickup housing 111. The planet gears 131 are disposed on both ends of the idle pin 131a to be respectively rotatable therewith. According to an embodiment of the invention, the idle pin 131a is cut into a D-lettered shape at the both ends thereof, so that the idle pin 131a rotates along with the planet gears 131 when the idle pin 131a is combined with the planet gears 131.

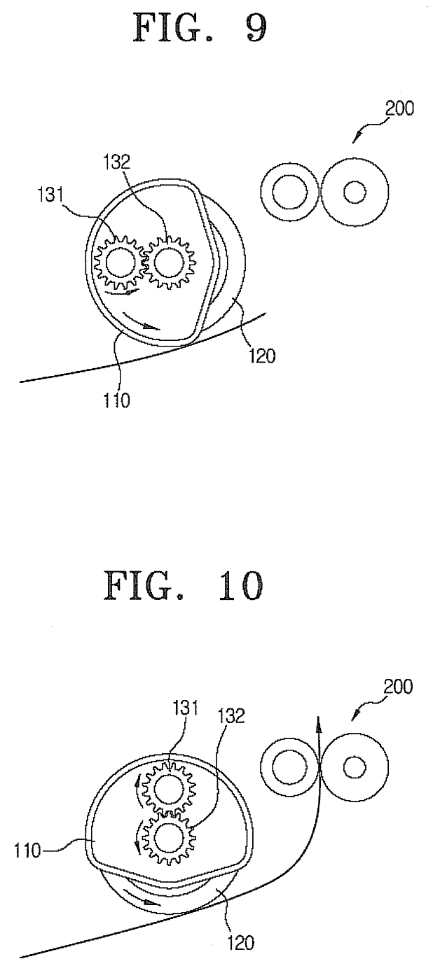

The sun gears 132 are integrally formed to inner idle housings 121 which are respectively disposed in outer idle housings 122 on both sides of the idle roller 120. As illustrated in FIGS. 6, 7 and 8, the sun gears 132 are coaxial with an axis of rotation 101 on which the idle rollers 120 are mounted. As such, the sun gears 132 engage with the planet gears 131. Accordingly, as illustrated in FIGS. 9 and 10, when the pickup roller 110 rotates during a medium (such as a piece of paper) pickup operation, the planet gears 131 rotate and simultaneously revolve around the sun gears 132. Further, when the idle rollers 120 are idled due to friction with the medium, the planet gears 131 rotate in connection with rotations of the sun gears 132 but do not revolve around the sun gears 132.

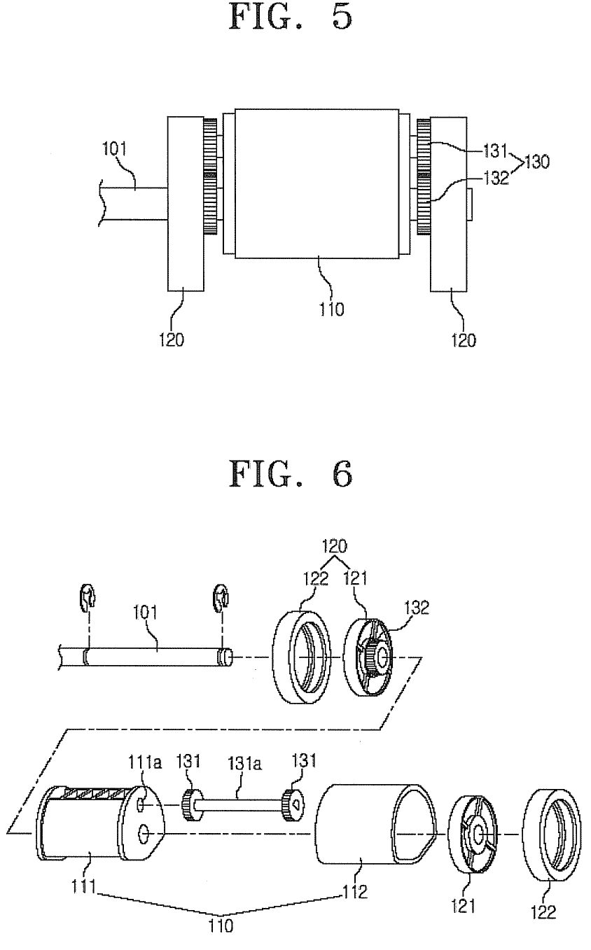

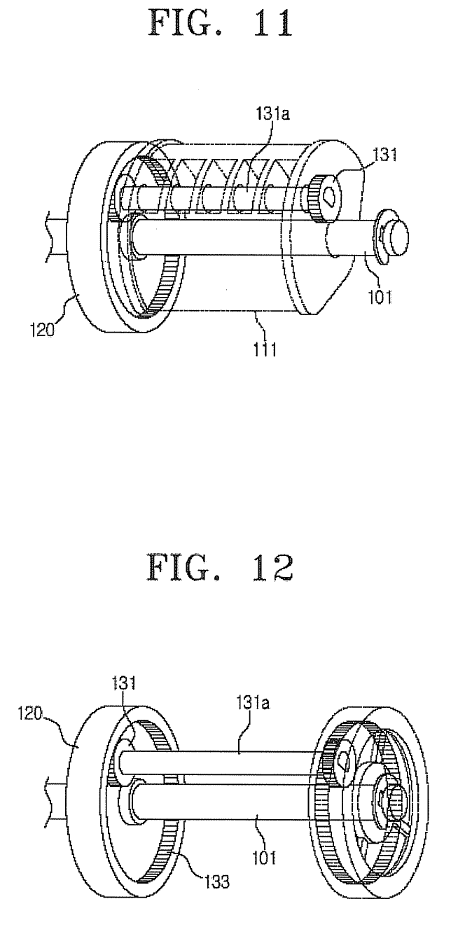

According to another embodiment of the present invention, as illustrated in FIGS. 11 through 13, a connecting unit 130 includes an idle pin 131a, planet gears 131 and ring gears 133. Since constructions of the idle pin 131a and planet gears 131 are similar to those in the preceding exemplary embodiment as described with reference to FIGS. 5 through 10 above, a detailed description thereof will be omitted for clarity and conciseness.

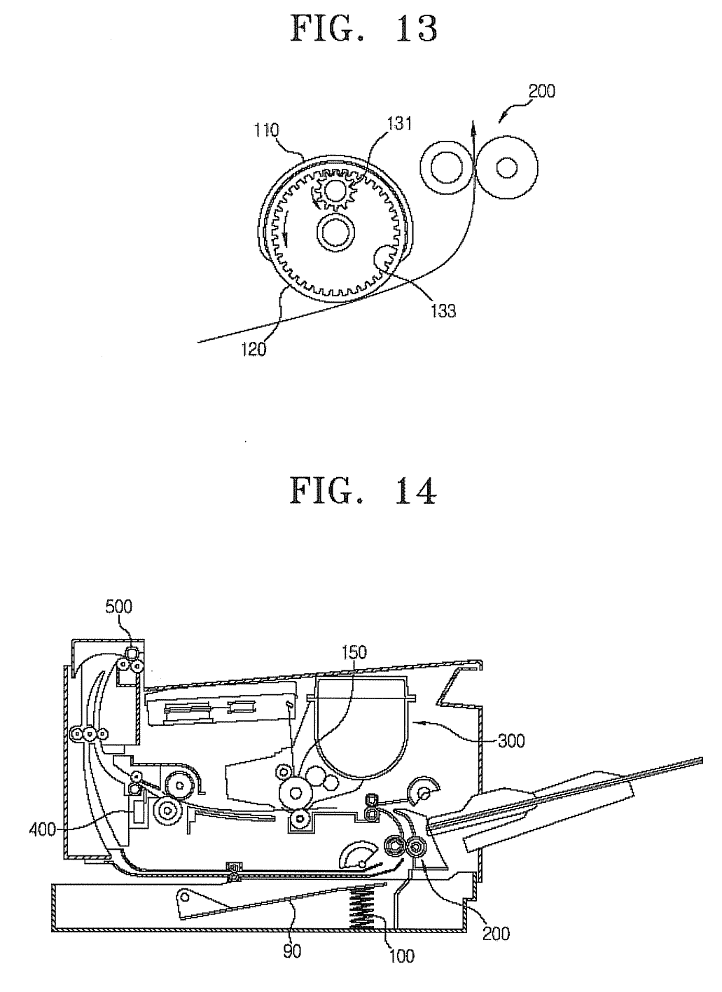

As illustrated in FIGS. 11 and 12, ring gears 133 are formed on inner circumferential surfaces of the idle rollers 120, respectively. The ring gears 133 engage with the planet gears 131. Accordingly, the idle rollers 120 rotate together. As illustrated in FIGS. 11 and 13, when the pickup roller 110 rotates to pick up a medium at the circumferential section thereof, the planet gears 131 also rotate and simultaneously revolve around the ring gears 133. When the pickup roller 110 stops rotating and the idle rollers 120 rotate, the planet gears 131 rotate in connection with rotations of the ring gears 133.

Hereinafter, an operation of the medium pickup unit according to the exemplary embodiment of the present invention will now be described with reference to the drawing figures.

FIGS. 9 and 10 are schematic views exemplifying an operation of the medium pickup unit 100. Particularly, FIG. 9 illustrates a state in which the pickup roller 110 picks up a medium at a circumferential section thereof, and FIG. 10 illustrates a state in which idle rollers 120 prevent the medium from twisting when the medium is admitted to a medium conveying unit 200.

As illustrated in FIG. 9, when picking up a medium, the pickup roller 110 rotates and, thus, contacts the medium at the circumferential section thereof. Here, only the pickup roller 110 rotates with the idle rollers 120 being stopped. This is due to the fact that the circumferential section of the pickup roller 110 at the circumferential section thereof has a diameter that is slightly larger than that of the idle rollers 120. At this time, since the planet gears 131 are mounted to the pickup roller 110 to be idled by the idle pin 131a, they rotate and revolve around the sun gears 132 formed on the idle rollers 120. With this construction, when the pickup roller 110 picks up the medium, the idle rollers 120 are stopped.

As illustrated in FIG. 10, when the medium is admitted to the medium conveying unit 200, the pickup roller 110 rotates to allow the non-circumferential section thereof to face the medium in conveyance. Thus, the pickup roller 110 separates itself from the medium. At this time, the medium, which is conveyed by the medium conveying unit 200, causes the idle rollers 120 to rotate. Here, the sun gears 132 that are integrally formed with the idle rollers 120 also rotate along with the idle rollers 120 and, as such, run through the same number of rotations as the idle rollers 120. However, since the planet gears 131 are connected together through the idle pin 131a, the idle rollers 120 mounted on the both sides of the pickup roller 110 are restricted to run through the same number of rotations.

As the idle rollers 120 run through the same number of rotations, the medium in conveyance moves straight in a medium proceeding direction. That is, a likelihood of a medium supplying error, such as a twisting of the medium twist or a jamming of the medium, is prevented from occurring even though a separate medium guide is not installed.

FIGS. 11 and 12 illustrate the medium pickup unit according to another exemplary embodiment. Here, the idle rollers 120 mounted on the both sides of the pickup roller 110 are connected together to run through the same number of rotations. That is, as illustrated in FIG. 13, when the idle rollers 120 are idled by the medium in conveyance, the ring gears 133, formed in the idle rollers 120, run through the same number of rotations as the idle rollers 120. Since the planet gears 131 that are engaged with the ring gears 133 are connected together through the idle pin 131a, they run through the same number of rotations. Accordingly, the idle rollers 120 run through the same number of rotations as each other.

As illustrated in FIG. 14, an image forming apparatus according to aspects of the present invention includes a medium supplying cassette 90, and a medium pickup unit 100. Media accommodated in the medium supplying cassette 90 are picked up in a one by one sequence by the medium pickup unit 100 without being twisted. The picked-up medium is then conveyed to a developing unit 300 to have a desired image formed thereon. Then; the image formed on the medium is heated and compressed by a fixing unit 400 so that the image is fixed on the medium. The medium is then discharged outside the image forming apparatus through a medium discharging unit 500.

As is apparent from the foregoing description, according to aspects of the exemplary embodiments of the present invention, the medium pickup unit and the image forming apparatus having the same installed therein are configured so that the idle rollers mounted at the both sides of the pickup roller rotate at the same speed. Accordingly, the rear end of the medium is prevented from twisting while the medium picked up from the medium supplying cassette is conveyed by the medium conveying unit. Thus, the medium is conveyed in as straight a line as possible, thereby allowing quality in conveyance to improve.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A medium pickup unit comprising:
a pickup roller, having a circumferential section and a non-circumferential section, to rotate and to pick up a medium due to friction between the circumferential section and the medium;
idle rollers respectively disposed at opposite ends of the pickup roller to maintain an orientation of the medium once the non-circumferential section of the pickup roller faces the medium during the rotation of the pickup roller; and
a connecting unit coupled to the pickup roller to cause the idle rollers to rotate together.

2. The medium pickup unit according to claim 1, wherein the connecting unit comprises:
an idle pin to penetrate the pickup roller from one end to the other;
planet gears respectively disposed on opposite ends of the idle pin; and
sun gears disposed on the idle rollers to respectively engage with the planet gears.

3. The medium pickup unit according to claim 2, wherein the planet gears rotate and at the same time, revolve around the sun gears when the pickup roller rotates to pick up the medium.

4. The medium pickup unit according to claim 3, wherein the planet gears rotate in connection with rotations of the sun gears when the idle rollers are rotated by the picked-up medium.

5. The medium pickup unit according to claim 1, wherein the connecting unit comprises:
an idle pin to penetrate the pickup roller;
planet gears respectively disposed on opposite ends of the idle pin; and
ring gears disposed on inner circumferential surfaces of the idle rollers to respectively engage with the planet gears.

6. The medium pickup unit according to claim 5, wherein the planet gears rotate and simultaneously revolve along the ring gears when the pickup roller rotates to pick up a medium.

7. The medium pickup unit according to claim 6, wherein the planet gears rotate in connection with rotations of the ring gears when the idle rollers are rotated by the picked-up medium.

8. An image forming apparatus comprising:
a medium supplying cassette; and
a medium pickup unit to pick up a medium accommodated in the medium supplying cassette,
wherein the medium pickup unit comprises:
a pickup roller, having a circumferential section and a non-circumferential section, to rotate and to pick up the medium due to friction between the circumferential section and the medium;
idle rollers respectively disposed at opposite ends of the pickup roller to maintain an orientation of the medium once the non-circumferential section of the pickup roller faces the medium during the rotation of the pickup roller; and
a connecting unit coupled to the pickup roller to cause the idle rollers to rotate together.

9. The image forming apparatus according to claim 8, wherein the connecting unit comprises:
an idle pin to penetrate the pickup roller from one end to the other;
planet gears respectively disposed on opposite ends of the idle pin; and
sun gears disposed on the idle rollers to respectively engage with the planet gears.

10. The image forming apparatus according to claim 9, wherein the planet gears rotate and at the same time, revolve around the sun gears when the pickup roller rotates to pick up the medium.

11. The image forming apparatus according to claim 10, wherein the planet gears rotate in connection with rotations of the sun gears when the idle rollers are rotated by the picked-up medium.

12. The image forming apparatus according to claim 8, wherein the connecting unit comprises:
an idle pin to penetrate the pickup roller;
planet gears respectively disposed on opposite ends of the idle pin; and
ring gears disposed on inner circumferential surfaces of the idle rollers to respectively engage with the planet gears.

13. The image forming apparatus according to claim 12, wherein the planet gears rotate and simultaneously revolve along the ring gears when the pickup roller rotates to pick up a medium.

14. The image forming apparatus according to claim 13, wherein the planet gears rotate in connection with rotations of the ring gears when the idle rollers are rotated by the picked-up medium.

15. The image forming apparatus according to claim 8, further comprising:
a developing unit to form an image on the medium;
a fixing unit to fix the image on the medium; and
a discharging unit to discharge the medium from the apparatus once the image is fixed thereon.

16. A medium pickup unit of an image forming apparatus to pick up a medium to be fed through the apparatus from a stack of media held in a cassette, the medium pickup unit comprising:
a pickup roller rotated by the apparatus about an axis of rotation to pick up the medium, a cross section of the pickup roller including a circular portion to contact the medium during the rotation and a non-circular portion to release the medium during the rotation;
a connecting pin to penetrate the pickup roller from one end thereof to the other such that the connecting pin rotates about the axis of rotation;
idle rollers to contact the medium once the pickup roller releases the medium; and
a gear system to transmit the rotation of the connecting pin about the axis of rotation to the idle rollers.

17. The medium pickup unit according to claim 16, wherein the connecting pin freely rotates within a longitudinal hole defined in the pickup roller.

18. The medium pickup unit according to claim 17, wherein a movement of the medium resulting in a rotation of one of the idle rollers is transmitted to the connecting pin but not to the pickup roller.

19. The medium pickup unit according to claim 17, wherein a movement of the medium resulting in a rotation of one of the idle rollers is transmitted to the other idle roller.

20. The medium pickup unit according to claim 16, wherein the image forming apparatus comprises:
a developing unit to form an image on the medium;
a fixing unit to fix the image on the medium; and
a discharging unit to discharge the medium from the apparatus once the image is fixed thereon.
